(19) United States
(12) Patent Application Publication
(10) Pub. No.: US 2005/0136148 A1
(43) Pub. Date: Jun. 23, 2005

(54) Concrete block configuration and method of using the same

(76) Inventor: William Martin, Bloomfield Hills, MI (US)

Correspondence Address: HARNESS, DICKEY & PIERCE, P.L.C., P.O. BOX 828, BLOOMFIELD HILLS, MI, 48303, US

(21) Appl. No.: 10/744,417

(22) Filed: Dec. 22, 2003

(51) Int. Cl. B28B 7/00

(52) U.S. Cl. 425/458; 425/403; 425/470

(57) ABSTRACT

A pattern is selected from a plurality of patterns. A plurality of stone cells are assembled relative to each other in accordance with a fixed configuration. The assembled stone cells define a stone unit. A plurality of stone units are assembled and positioned relative to each other. A surface is constructed with the plurality of stone units positioned in accordance with the pre-selected pattern.

### FIELD OF THE INVENTION

The present invention relates to concrete walkways, and more particularly, to preformed concrete walkways.

### BACKGROUND OF THE INVENTION

Walkways and patios are typically formed of concrete, brick pavers, or stone. Concrete surfaces must be formed, poured, and trowelled to a desired finish by a skilled artisan. Also, concrete surfaces can lack style, feel, and elegance. Brick paver surfaces require careful positioning of many small bricks on a compacted slag or earth surface. This construction can be very time consuming. Also, the brick pavers can be prohibitively expensive. Stone surfaces, such as flagstone or fieldstone, require careful selection and positioning of random stones. While such stone surfaces can be elegant, construction can be prohibitively time-consuming.

### SUMMARY OF THE INVENTION

The present invention provides a method of assembling and constructing a hard surface covering, such as a walkway or patio. The first step is to select a pattern. The next step is to position a plurality of stone cells having distinct geometries relative to each other in accordance with a fixed configuration. The fixed configuration is defined by the distinct geometries of the stone cells. The positioned stone cells define a unit. Subsequently, another plurality of stone cells are positioned relative to each other in accordance with the same fixed configuration. This plurality of stone cells also defines a unit. This unit is positioned generally adjacent to the first unit according to the pre-selected pattern. Further pluralities of stone cells, which define further units, are positioned in accordance with the pre-selected pattern to create the desired walkway or patio.

In a further aspect of the present invention, the stone units each include a lateral edge having a first dimension and a longitudinal edge having a second dimension. The second dimension is approximately wholly divisible by the first dimension. In yet a further aspect of the present invention, each of the stone units include four distinct stone cells. In yet a further aspect of the present invention, each of the stone cells are molded of concrete to resemble natural stone, such as fieldstone or flagstone.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a concrete mold in accordance with the present invention;

FIG. 2 is an elevational view of a stone unit in accordance with the present invention;

FIG. 3A is a top elevational view of a first embodiment of an assembly step in accordance with the present invention;

FIG. 3B is a top elevational view of a second embodiment of an assembly step in accordance with the present invention;

FIG. 4A is a top elevational view of a first embodiment of a pattern in accordance with the present invention;

FIG. 4B is a top elevational view of a second embodiment of a pattern in accordance with the present invention;

FIG. 4C is a top elevational view of a third embodiment of a pattern in accordance with the present invention;

FIG. 4D is a top elevational view of a fourth embodiment of a pattern in accordance with the present invention; and

FIG. 4E is a top elevational view of a fifth embodiment of a pattern in accordance with the present invention.

### DETAILED DESCRIPTION OF THE PREFERRED EMBODIMENTS

The following description of the preferred embodiment(s) is merely exemplary in nature and is in no way intended to limit the scope of the invention, its application, or its uses.

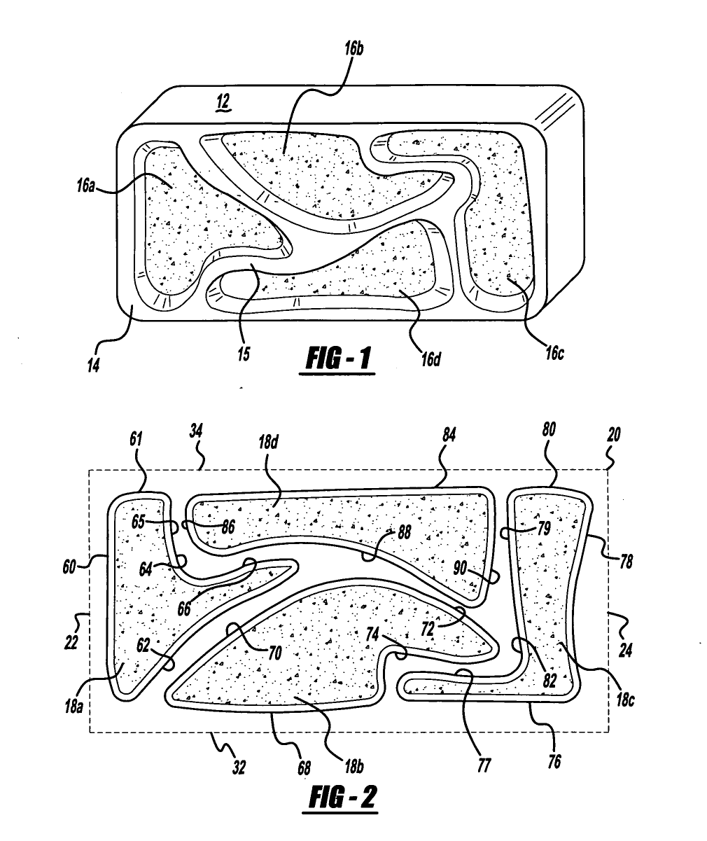

FIG. 1 illustrates a mold 10 for constructing a surface covering in accordance with the present invention. The mold 10 generally includes a body 12, which has a working surface 14 and a plurality of cavities 16a, 16b, 16c, and 16d. The mold also has a network of walls 15 disposed between the body 12 and the working surface 14. The walls 15 have a base portion attached to the body 12 and a top portion mating with the working surface 14. The top portion is slightly narrower than the base portion such that the walls 15 are inclined. The walls 15 define the cavities 16a, 16b, 16c, and 16d to be distinctly shaped in a plane common with the working surface 14. In an exemplary embodiment, the cavities 16a, 16b, 16c and 16d are textured to impress a material contained therein. In an exemplary embodiment, the mold 10 has four cavities.

During use, the cavities 16a, 16b, 16c, and 16d are filled with a moldable material. In an exemplary embodiment, the cavities 16a, 16b, 16c, and 16d are filled with standard concrete. In an alternative embodiment, the moldable material may be dyed to reflect different types of stone. In yet an alternative embodiment, the cavities 16a, 16b, 16c, and 16d may be sprinkled with an abrasive material, such as sand, prior to filling them with moldable material. The abrasive material would provide for enhanced traction on the walking surface of the stones. The moldable material is then allowed to harden. This creates a plurality of corresponding stone cells 18a, 18b, 18c, and 18d. The stone cells 18a, 18b, 18c, and 18d are then removed from the cavities 16a, 16b, 16c, and 16d. The inclined network of walls 15 in the mold 10 help in removing the cells 18a, 18b, 18c, and 18d. The inclined network of walls 15 also provide the cells 18a, 18b, 18c and 18d with inclined sides. The inclined sides of the walls provide for a walkway or patio free from sharp corners or edges.

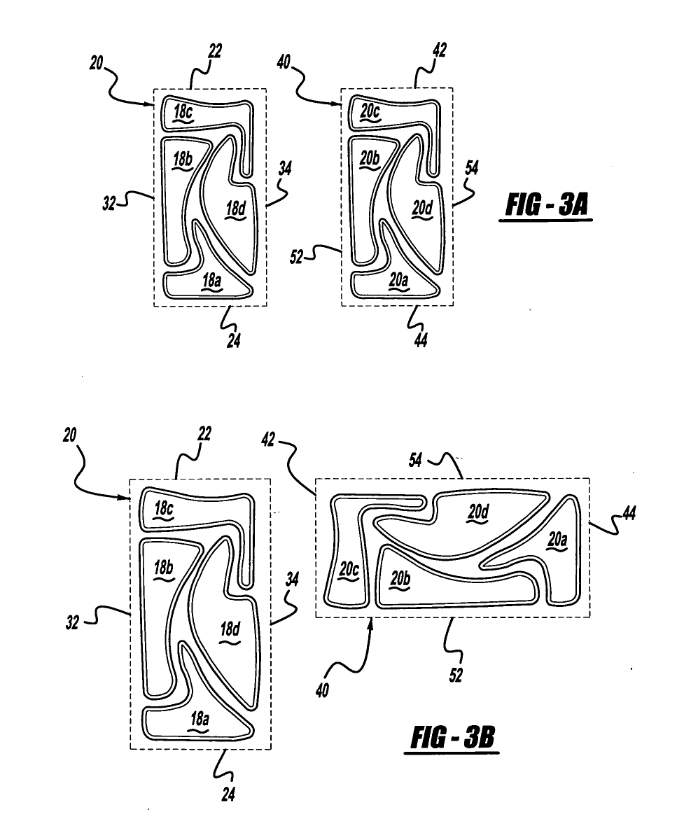

FIG. 2 illustrates a first plurality of stone cells 18a, 18b, 18c, and 18d in accordance with the present invention. The stone cells 18a, 18b, 18c, and 18d are assembled according to a fixed configuration. The fixed configuration is a product of the distinct geometries of the cells 18a, 18b, 18c, and 18d. The first cell 18a includes a lateral edge 60, a longitudinal edge 61, a first concave edge 62, and a second concave edge 64 having a first leg 65 and a second leg 66.

The second cell 18b includes a longitudinal edge 68, a first convex edge 70, a second convex edge 72, and a concave edge 74. The first convex edge 70 of the second cell 18b is interpositioned with and received by the concave edge 62 of the first cell 18a.

The third cell 18c includes a first longitudinal edge 76, a lateral edge 78, a second longitudinal edge 80, and a concave edge 82 having a first leg 77 and a second leg 79. The first leg 77 of the concave edge 82 of the third cell 18c is interpositioned with the concave edge 74 of the second cell 18b.

The fourth cell 18d includes a longitudinal edge 84, a first convex edge 86, a concave edge 88, and a second convex edge 90. The first convex edge 86 of the fourth cell 18d is interpositioned with and received by the first leg 65 of the second concave edge 64 of the first cell 18a. The concave edge 88 of the fourth cell 18d is interpositioned with and in receipt of the second convex edge 72 of the second cell 18b and the second leg 66 of the concave edge 64 of the first cell 18a. The second convex edge 90 of the fourth cell 18d is interpositioned with and received by the second leg 79 of the concave edge 82 of the third cell 18c.

The assembled stone cells 18a, 18b, 18c, and 18d define a first stone unit 20. The first stone unit 20 is generally rectangular in shape and has first and second lateral edges 22, 24 of a first dimension and first and second longitudinal edges 32, 34 of a second dimension. The first lateral edge 22 is generally defined by lateral edge 60 of the first cell 18a. The second lateral edge 24 is generally defined by the lateral edge 78 of the third cell 18c. The first longitudinal edge is generally defined by the longitudinal edge 68 of the second cell 18b and the first longitudinal edge 76 of the third cell. The second longitudinal edge 34 is generally defined by the second longitudinal edge 80 of the third cell 18c, the longitudinal edge 84 of the fourth cell 18d, and the longitudinal edge 61 of the first cell 18a. The second dimension of the stone unit 20 is approximately wholly divisible by the first dimension. In an exemplary embodiment, the second dimension is approximately twice the first dimension.

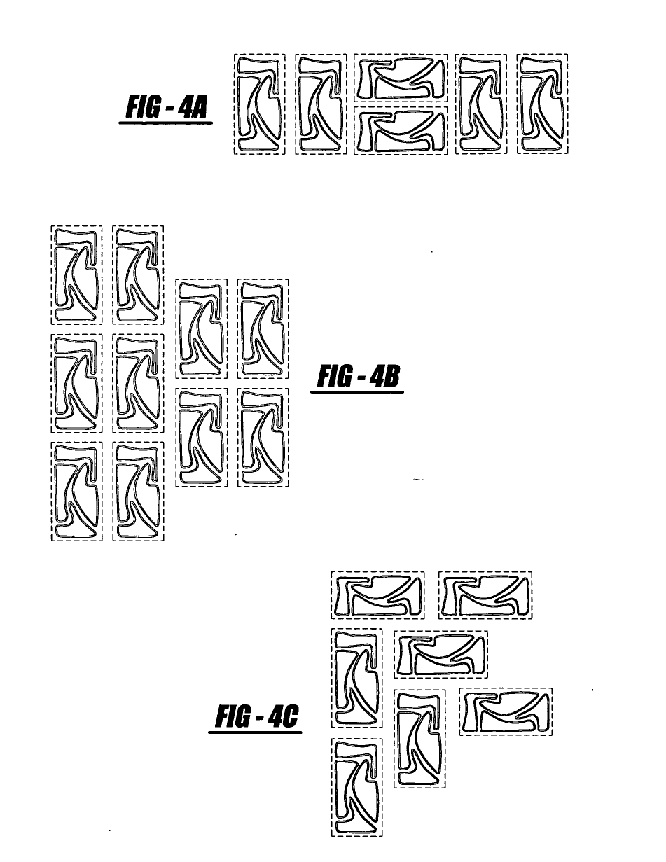

FIGS. 3A and 3B illustrate further assembly of the surface covering in accordance with the present invention. Subsequent to the first stone unit 20 being assembled, further stone units are assembled. A second plurality of stone cells 28a, 28b, 28c, and 28d are generally identical to the first plurality of stone cells 18a, 18b, 18c, and 18d because they are constructed from the same mold 10. Also, the second plurality of stone cells 28a, 28b, 28c, and 28d are assembled in accordance with the same fixed configuration as the first plurality of stone cells 18a, 18b, 18c, and 18d. The assembled second plurality of stone cells 28a, 28b, 28c, and 28d define a second stone unit 40. The second stone unit 40 is generally identical to the first stone unit 20. The second stone unit 40 is generally rectangular in shape and has lateral edges 42, 44 of a first dimension and longitudinal edges 52, 54 of a second dimension. The second stone unit 40 is assembled generally adjacent to the first stone unit 20 in accordance with a pre-selected pattern.

In an exemplary embodiment, a longitudinal edge 52 of the second stone unit 40 is positioned generally adjacent to a longitudinal edge 34 of the first stone unit 20, as shown in FIG. 3A. In an alternative exemplary embodiment, a lateral edge 42 of the second stone unit 40 is positioned generally adjacent to a longitudinal edge 34 of the first stone unit 20, as shown in FIG. 3B. It should be appreciated that alternative positions for the second stone unit 40 are intended to be within the scope of the present invention.

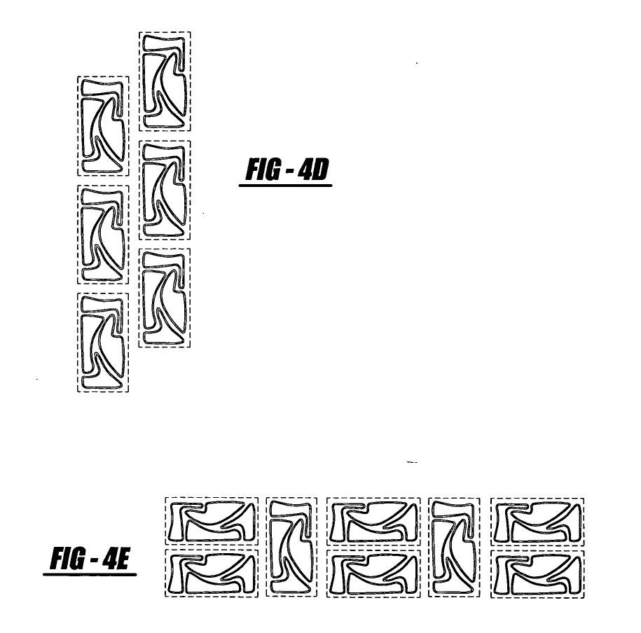

FIGS. 4A-4E illustrate a plurality of alternative patterns attainable with the surface covering of the present invention. FIG. 4A illustrates a double crosshatch pattern. FIG. 4B illustrates a double running pattern. FIG. 4C illustrates a herringbone pattern. FIG. 4D illustrates a single running pattern. FIG. 4E illustrates an alternating single/double crosshatch pattern. It should be appreciated that the patterns illustrated herein are merely exemplary. Alternative patterns are intended to be within the scope of the present invention. The pre-selected pattern is assembled with a plurality of stone units 20, 40, as described above, to construct a walkway or patio.

The description of the invention is merely exemplary in nature and, thus, variations that do not depart from the gist of the invention are intended to be within its scope. Such variations are not to be regarded as a departure from the spirit and scope of the invention.

1. A device for molding a surface covering, said device comprising:
a mold body;
a working surface disposed on said mold body; and
a plurality of cavities in said mold body adapted to receive a moldable material;
said plurality of cavities each having a distinct geometry in a plane common with said working surface to define said moldable material into a plurality of cells having a fixed interpositionable configuration such that positioning said plurality of cells according to said configuration defines a unit having a first dimension and a second dimension approximately wholly divisible by said first dimension.

2. The device of claim 1, wherein said plurality of cavities includes a first, second, third and fourth cavity.

3. The device of claim 1, wherein said plurality of cavities each include a textured cavity for impressing said moldable material such that said plurality of cells resemble natural stone.

4. The device of claim 1, further comprising a cavity wall disposed between said mold body and said working surface for binding said plurality of cavities.

5. The device of claim 4, wherein said wall has a base adjacent said mold body having a base dimension and a top adjacent said working surface have a top dimension smaller than said base dimension.

6. The device of claim 2, wherein said first cavity has a concave edge receiving said fourth cavity, said second cavity has a concave edge receiving said third cavity, said third cavity has a concave edge receiving said second and fourth cavities, and said fourth cavity has a concave edge receiving said first and second cavities.

7. A method of constructing a surface covering, said method comprising the steps of:
selecting a pattern;
positioning a plurality of cells relative to each other according to a fixed configuration defined by said plurality of cells to create a unit; and
positioning a plurality of units relative to each other according to said pattern.

8. The method of claim 7, wherein each of said units include a first dimension and a second dimension approximately wholly divisible by said first dimension.

9. The method of claim 9, wherein said second dimension is approximately twice said first dimension.

10. The method of claim 8, further comprising the step of molding said plurality of cells prior to positioning said plurality of cells.

11. The method of claim 10, wherein said step of molding said plurality of cells includes filling a plurality of cavities with a moldable material.

12. The method of claim 11, wherein said moldable material is concrete.

13. The method of claim 7, wherein said plurality of cells resemble natural stone.

14. The method of claim 11, further comprising the step of allowing said moldable material to harden in said plurality of cavities to create said plurality of cells.

15. The method of claim 14, further comprising the step of removing said plurality of cells from said plurality of cavities.

16. The method of claim 8, wherein said step of positioning a plurality of cells includes positioning a first cell having a semi-concave edge on a surface, positioning a second cell having a semi concave edge substantially adjacent to said semi-concave edge of said first cell, positioning a third cell having a concave edge substantially adjacent said semi-concave edge of said second cell, positioning a fourth cell adjacent a concave edge of said first cell.

17. A method for assembling a surface covering, said method comprising the steps of:
selecting a pattern;
positioning a first plurality of cells according to a fixed configuration defined by said first plurality of cells to create a first unit generally rectangular in shape having a lateral edge of a first dimension and a longitudinal edge of a second dimension, said second dimension approximately wholly divisible by said first dimension; and
positioning a second plurality of cells substantially identical to said first plurality of cells according to said fixed configuration to create a second unit generally rectangular in shape having a lateral edge of said first dimension and a longitudinal edge of said second dimension such that the combination of said first and second units creates said pattern.

18. The method of claim 17, wherein said second unit is positioned such that one of said lateral and longitudinal edges of said second unit is generally adjacent to said longitudinal edge of said first unit.

19. The method of claim 17, wherein said second unit is positioned such that one of said lateral and longitudinal edges of said second unit is generally adjacent to said lateral edge of said first unit.

20. The method of claim 17, wherein said step of positioning a first plurality of cell includes positioning a first cell having a semi-concave edge on a surface, positioning a second cell having a semi concave edge substantially adjacent to said semi-concave edge of said first cell, positioning a third cell having a concave edge substantially adjacent said semi-concave edge of said second cell, positioning a fourth cell adjacent a concave edge of said first cell.

21. The method of claim 20, wherein said step of positioning a second plurality of cells includes positioning a first cell having a semi-concave edge on a surface, positioning a second cell having a semi concave edge substantially adjacent to said semi-concave edge of said first cell, positioning a third cell having a concave edge substantially adjacent said semi-concave edge of said second cell, positioning a fourth cell adjacent a concave edge of said first cell.

22. The method of claim 17, wherein said first and second pluralities of cells are molded of concrete to resemble natural stone.

23. The method of claim 17, wherein said second dimension is approximately twice said first dimension.
